(19) United States
(12) Patent Application Publication
(10) Pub. No.: US 2016/0036164 A1
(43) Pub. Date: Feb. 4, 2016

(54) Electrical Plug Fastener

(71) Applicant: Vaios Bozikis, Moraga, CA (US)

(72) Inventor: Vaios Bozikis, Moraga, CA (US)

(73) Assignee: Vaios Bozikis

(21) Appl. No.: 14/450,303

(22) Filed: Aug. 4, 2014

(51) Int. Cl. H01R 13/639

(52) U.S. Cl. CPC H01R 13/6392

(57) ABSTRACT

A system which secures an electrical connection so as to prevent accidental disconnection.

### BACKGROUND

### Field of Invention

The invention relates to a fastener, lock, or clamp, for preventing electrical plugs from becoming unintentionally disconnected. Electrical plugs often become unintentionally disconnected when powering mobile devices such as power tools.

### SUMMARY OF THE INVENTION

The purpose of this invention is to prevent unintentional separation of electrical plugs connecting electrically powered devices or power cords. One advantage of this invention is that it quickly engages or disengages to and from conjoining plugs, yet while engaged the connection is secure enough to ensure the plugs will remain connected until connection is intentionally broken. Another advantage of this invention is that the entire device is contained on one plug or is completely mobile so no specially designed plug is necessary to create a locked connection. In other words a plug with this mechanism can lock to any standard plug.

### BRIEF DESCRIPTION OF DRAWINGS

FIG. 1, the Invention in an unmodified form stripped of electrical plugs to show what the invention is comprised of.

FIG. 2, side view of invention installed in electrical plug, showing how arms move clamp into engaged position.

FIG. 3, top view of invention showing clamp installed in extrication plug, securing it to another plug.

FIG. 4, cross-section of clamp.

FIG. 5, close up of locking mechanism in clamp.

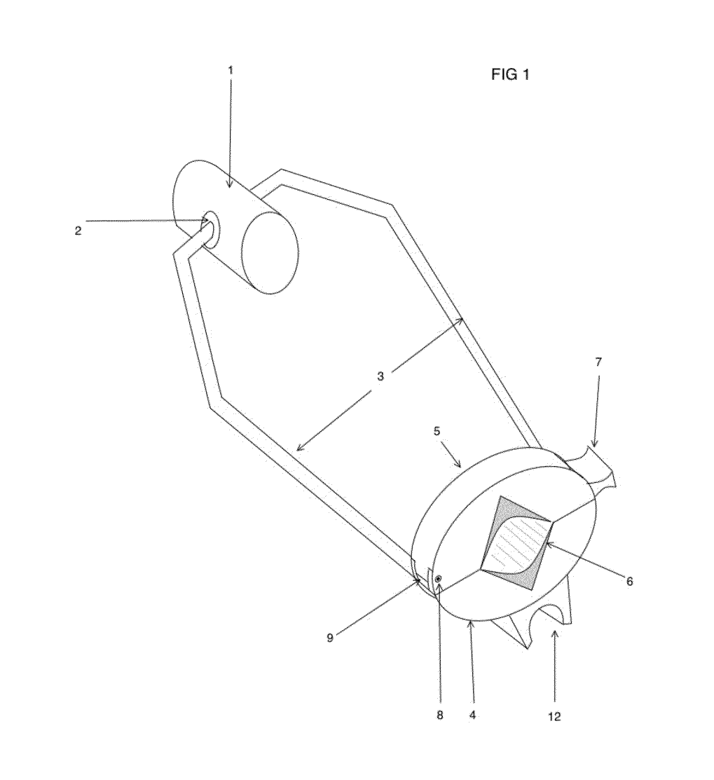

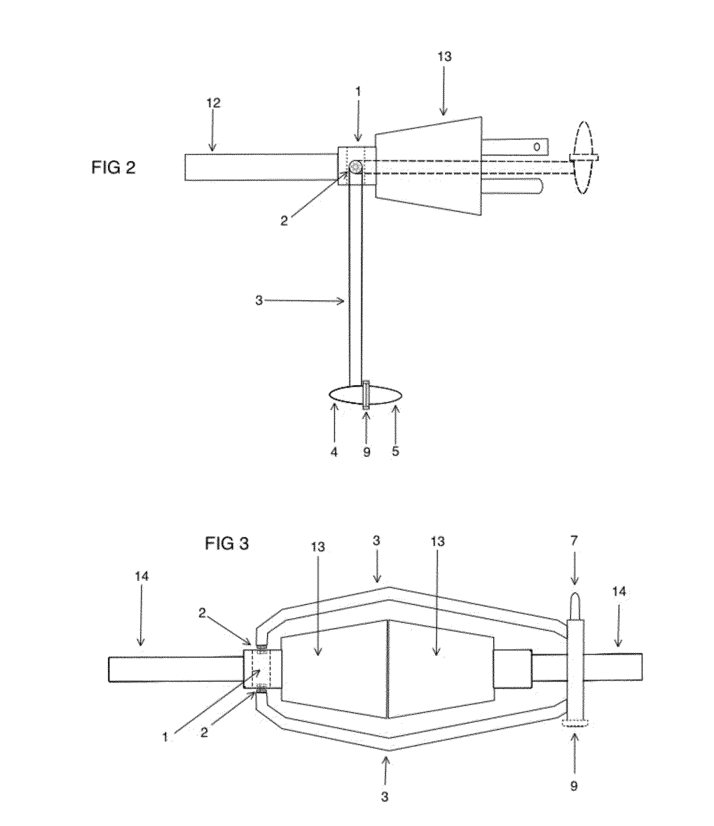

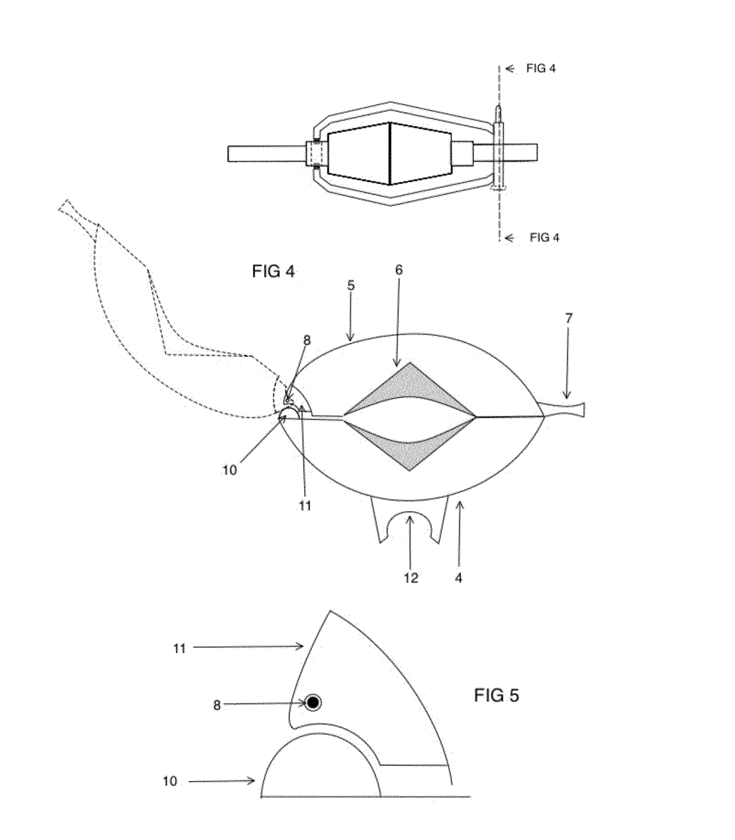

### DETAILED DESCRIPTION OF THE INVENTION

This mechanism fastens disconnect-able electrical plugs together so that accidental disconnection does not occur. It is designed to fasten the plugs together in a manner such that they will remain connected until intentionally disconnected, even under high amounts of force that they may be susceptible to in construction zones when people are tugging on cords, or similar situations. The device is easily engaged or disengaged, yet when engaged, the connection is secure, so that the invention is efficient and effective.

The invention consists of: a metal cylinder 1) imbedded in electrical plug where the electrical wiring runs through the cylinder. The cylinder has two holes that hold pins with stoppers on both sides of the holes, creating a hinge 2). The outer portion of the hinges are connected to metal arms 3) (which may be coated in rubber). Arms extend out and around electrical plugs 13), once clear of conjoining plug they connect to the bottom portion of the clamp 4) which is connected to the top of the clamp 5) with a hinge 9). The hinge 9) consists of teeth and a pin 8), as well as a rounded bar 10) connected to bottom portion of the clamp 4), and a elliptical piece 11) connected to the top of the clamp 5), which will create an increased point of friction right before clamp is fully engaged so as to fix the clamp in the locked position. These two pieces 10) and 11) are made from polished stainless steel or a similar material so as to not corrode, and to slide past each other at heightened point of friction. Both the top and bottom portions of the clamp 4) and 5) have a rubber center 6), allowing for a tight connection to the power cord 14) without damaging it and for increased friction between the clamp and power cord 14). The top portion of the clamp has a lever 7), allowing it to be manually engaged and disengaged. When disengaged, the clamp may be secured to the same power cord 12) as the base 1) (so as to not get in the way and flap around when the clamp is not needed) via a clip 12) attached to the bottom of the clamp 4).

Modifications: The clamp may be me modified to create a stronger connection, one example being the use of a clip on the side opposing the hinge to ensure the clamp stays closed.

The base 1) of the mechanism may also be modified so that it is attachable semi permanently with screws. The metal cylinder can also be replaced with a clamp identical to the opposing end, so as to make system quickly applicable to any set of plugs.

1. A system of binding electrical plugs so that accidental disconnection does not occur.
System is comprised of
a) One side which is connected or connects to plug or cord, equipped with a hinge therefore allowing the system to be put into an engage or disengaged position.
b) Bars connecting hinge portion of system to clamp enabling plug to become securely joined while system is engaged.
c) Clamp, allowing one plug to be securely and quickly held in place.
